(19) United States
(12) Patent Application Publication
(10) Pub. No.: US 2011/0079314 A1
(43) Pub. Date: Apr. 7, 2011

(54) PIPE JACKET

(75) Inventors: James Henry, The Woodlands, TX (US); Paul Brogan, The Woodlands, TX (US)

(73) Assignee: WINTEC GROUP LLC, THE WOODLANDS, TX (US)

(21) Appl. No.: 12/896,595

(22) Filed: Oct. 1, 2010

Related U.S. Application Data
(60) Provisional application No. 61/247,810, filed on Oct. 1, 2009.

(51) Int. Cl. F16L 9/14; B23P 11/00

(52) U.S. Cl. 138/147; 29/890.14

(57) ABSTRACT

A pipe jacket is disclosed for use with pipes such as hydrocarbon based liquid and gaseous high pressure oil pipelines. The pipe jacket exhibits ballistic self-sealing properties through the use of ballistic fabric surrounding a self-sealing core. The self-sealing core makes use of compressible polymers, which close back on themselves when a foreign object such as a bullet passes through to prevent most leakage, and a self-sealing fluid to fill in whatever space remains. The compressible polymers are kept under a pressure greater than the internal pipeline normal maximum operating pressure by a fastening system which securely fastens one end of the pipe jacket to the other after the pipe jacket is placed around the outside of the pipe. The pipe jacket may also optionally provide additional protection from blasts, electric drill sabotage, corrosion, and thermal variation.

This application is based on and derives the benefit of the filing date of U.S. Provisional Patent Application No. 61/247,810, filed Oct. 1, 2009, the contents of which are incorporated herein by reference.

### BACKGROUND OF THE INVENTION

### Field of the Invention

The present invention relates to a jacket for pipelines. In particular, the present invention relates to pipe jackets that can protect a pipe surface from tampering. Additionally, the invention relates to pipe jackets that can protect a pipe surface from environmental hazards. The invention also relates to pipe jackets that can provide thermal resistance. The invention further relates to pipe jackets which can be securely attached to a pipe surface.

### BRIEF DESCRIPTION OF THE DRAWINGS

The invention will be described in conjunction with the following drawings in which like reference numerals designate like elements and wherein:

FIG. 1 is an end-on cross-sectional view of a pipe jacket in accordance with an embodiment of the present invention;

FIG. 2 is an end-on cross-sectional view of a pipe jacket in accordance with another embodiment of the present invention wherein the pipe jacket is provided with blast resistant features;

FIG. 3 is an end-on cross-sectional view of a pipe jacket in accordance with another embodiment of the present invention wherein the pipe jacket is provided with drill prevention features;

FIG. 4 is an end-on cross-sectional view of a pipe jacket in accordance with another embodiment of the present invention wherein the pipe jacket is provided with insulation;

FIG. 5 is a top-down view of a pipe jacket primary attachment system in accordance with an embodiment of the present invention;

FIG. 6 is a side view of a pipe jacket secondary attachment system in accordance with an embodiment of the present invention.

### DETAILED DESCRIPTION OF SEVERAL EMBODIMENTS

Applicant has developed an innovative pipe jacket for use with pipes such as hydrocarbon based liquid and gaseous high pressure oil pipelines. This pipe jacket addresses pipeline security and flow assurance issues. The pipe jacket exhibits ballistic self sealing properties through the use of ballistic fabric surrounding a self-sealing core. The self-sealing core makes use of compressible polymers, which close back on themselves when a foreign object such as a bullet passes through to prevent most leakage, and a self-sealing fluid to fill in whatever space remains. The compressible polymers are kept under a pressure greater than the internal normal maximum operating pressure of the pipeline by a fastening system which securely fastens one end of the pipe jacket to the other after the pipe jacket is placed around the outside of the pipe. A secondary fastening system may be employed in some embodiments of the invention. This secondary system may utilize a one way ratchet to prevent the ends of the pipe jacket from sliding apart or releasing tension. The pipe jacket may be attached to the surface of the pipe with an adhesive. Some embodiments of the invention employ additional protective layers, including blast resistant layers, drill stopping layers, and thermal insulation layers. The pipe jacket may also protect the pipeline from both common and uncommon environmental corrosive elements.

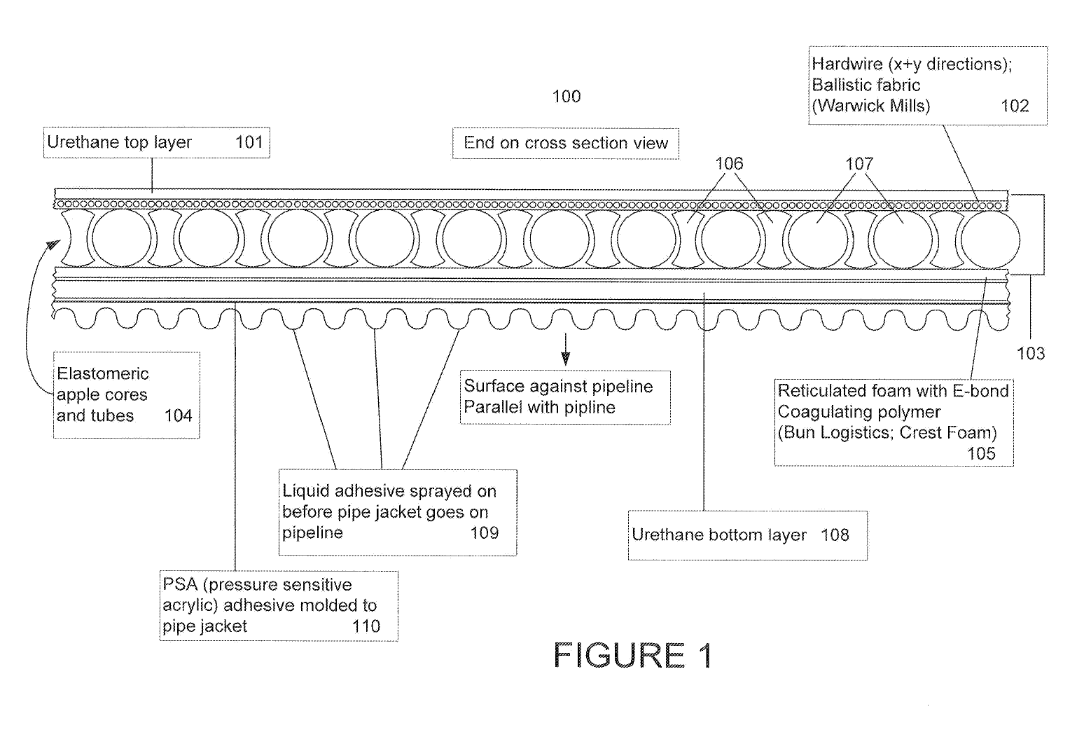

A pipe jacket will now be described in greater detail in connection with FIGS. 1-6. FIG. 1 shows a pipe jacket according to one embodiment of the invention. The pipe jacket 100 has a top layer 101 which may be made of urethane or another suitably flexible and impermeable material. A ballistic fabric layer 102 is disposed beneath the top layer 101. This may he one of several types of ballistic fabrics, for example it may one of the fabrics sold under the names of Hardwire, Kevlar, Vectran, or Dyneema. This ballistic fabric layer 102 provides ballistic protection and structural integrity for the pipe jacket 100.

A self-sealing layer 103 may be disposed beneath the ballistic fabric layer 102. This self-sealing layer 103 includes both a plurality of compressible structures 104 and a self-sealing fluid 105. In FIG. 1, the compressible structures 104 are a series of elastomeric “apple core” shapes 106 and tubes 107, arranged to interlock with one another. The heights of these compressible structures 104 may be varied according to the desired overall thickness of the pipe jacket 100. These are made of materials and shapes such that, when compressed in the vertical direction, they exert tremendous energy consequently in the lateral direction.

The pipe jacket 100 is tightened around the pipeline with a force exceeding a normal maximum operating pressure of the pipeline. This normal maximum operating pressure is caused by a fluid flowing through the pipeline. The normal maximum operating pressure is the pressure caused by the fluid flow when the flow is at a maximum rated or measured capacity of the pipeline. The normal maximum operating pressure is therefore a maximum pressure exclusive of excessive transient pressures both periodic and unique.

Therefore, when a foreign object such as a bullet or piece of shrapnel enters the self-sealing layer 103, the high energy exerted in the lateral direction causes the self-sealing layer 103 to close back on itself as soon as the foreign object passes through the self-sealing layer 103. This effectively seals nearly the entire hole created by the foreign object. The self-sealing fluid 105 fills the remaining portion of the hole. In FIG. 1, this self-sealing fluid 105 is a reticulated foam with E-bond coagulating polymer, a self-sealing mixture of a urethane and a coagulant that functions to change hydrocarbon based fuels or liquids into a solidified gelatinous mass. This self-sealing fluid 105 may be made of other materials, as long as it is capable of plugging a hole remaining after the self-sealing layer 103 closes back on itself.

A bottom layer 108, which may be made of urethane or another suitably flexible and impermeable material, is disposed beneath the self-sealing layer 103. The urethane or other material of the top layer 101 and bottom layer 108 is selected in part based on anti-corrosive properties. For example, urethane forms a sealed barrier that protects the pipeline surface from acidic and corrosive chemicals, salt water spray, natural exposure to wind, rain, acid rain, sunlight, condensation, human and animal waste, fertilizers, etc. If environmental factors are present for which urethane is not suitable as a protectant, other materials may be chosen or custom-designed to serve as corrosion resistant layers. Adhesives may be disposed between the bottom layer 108 and the surface of the pipeline. In FIG. 1, a liquid adhesive 109 is sprayed on the pipeline, and a pressure sensitive acrylic adhesive 110 is applied to the bottom layer 108. This combination is displayed because it allows the pipe jacket 100 to be positioned before drying, and allows for imperfections in the pipeline surface to be filled with adhesive. However, other suitable adhesives may be used.

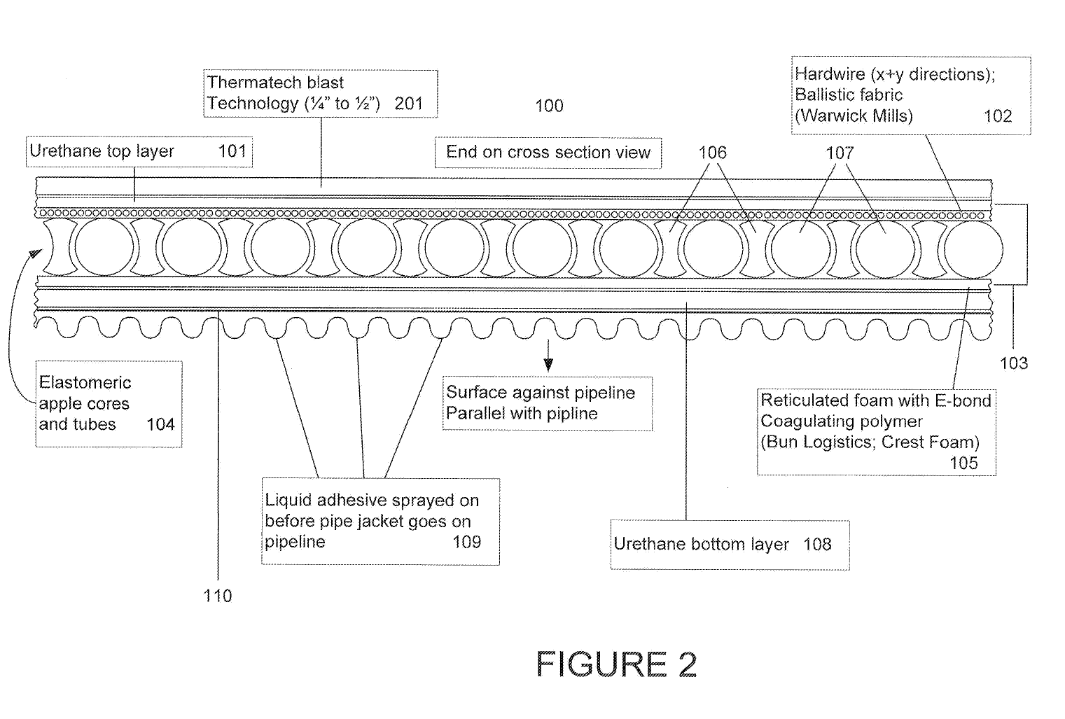

FIG. 2 shows a pipe jacket 100 according to another embodiment of the invention. This embodiment is similar to that of FIG. 1, but with the addition of a blast resistant layer 201 disposed above the top layer 101. For example, this blast resistant layer 201 may be applied as a coating of elastic epoxy embedded with solid and hollow micro beads.

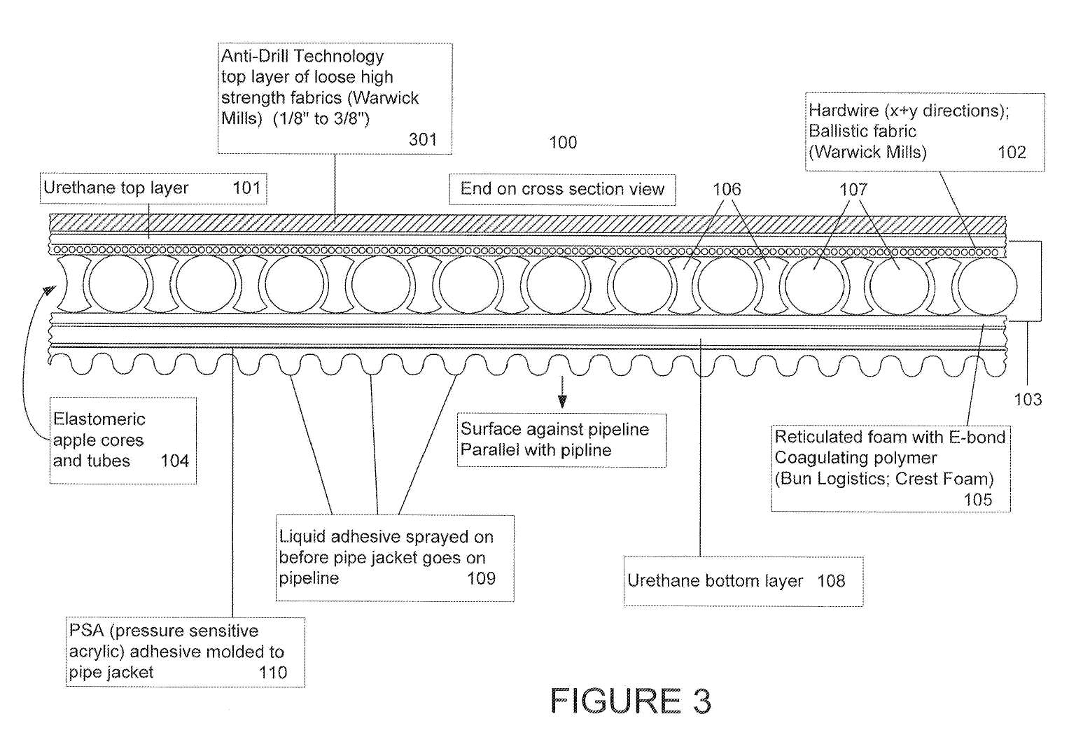

FIG. 3 shows a pipe jacket 100 according to another embodiment of the invention. This embodiment is similar to that of FIG. 1, but with the addition of an anti-drill fabric layer 301 disposed above the top layer 101. The anti-drill fabric layer 301 of FIG. 3 may incorporate a plurality of fabrics of high strength that are loosely woven into a sacrificial fabric structure. The fabrics grab a turning drill bit and wind around it, stopping the motor and disabling the drill.

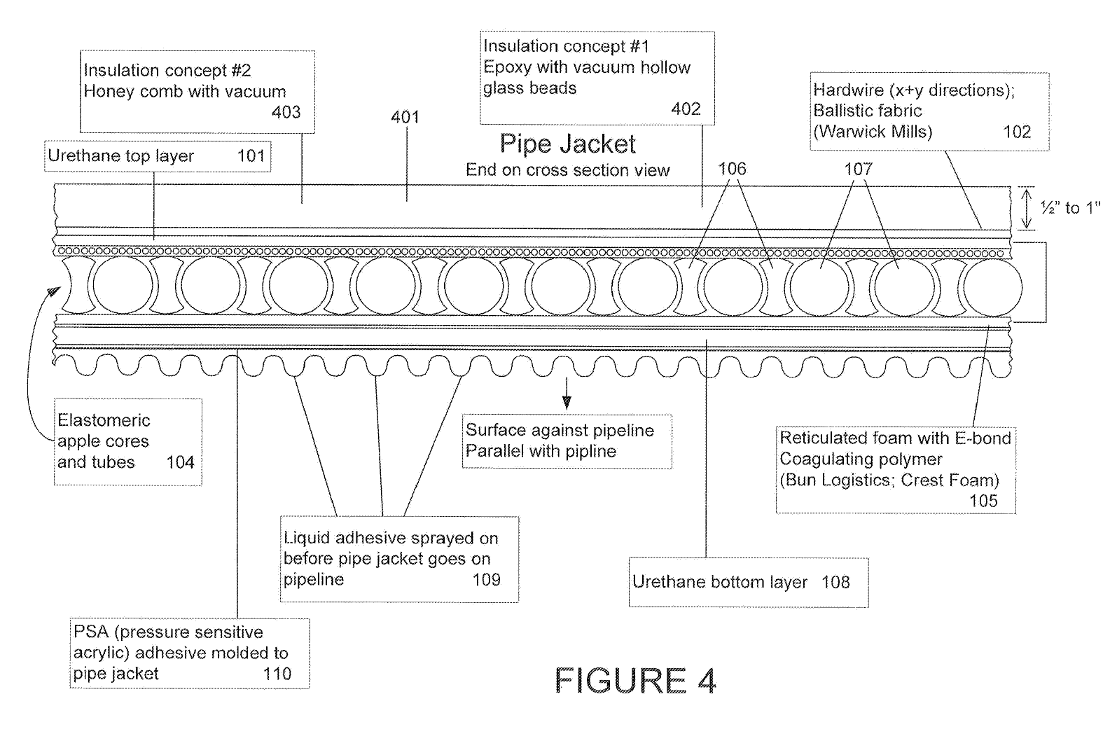

FIG. 4 shows a pipe jacket 100 according to another embodiment of the invention. This embodiment is similar to that of FIG. 1, but with the addition of a thermal insulation layer 401 disposed above the top layer 101. Some fuels, such as unrefined petroleum, must remain warm in order to retain a high enough viscosity to be effectively transported through a pipeline. This may make thermal insulation necessary. FIG. 4 shows two possible thermal insulation layer 401 options. One option is a layer of epoxy resin 402 containing small glass beads. Each bead encloses a vacuum. A second option is a layer of material having a honey comb structure 403 that contains a vacuum within the internal honey comb voids of the structure. Vacuum based insulators are pictured in FIG. 4 because partial vacuums are excellent thermal insulators. However, it is possible to use a thermal insulation layer 401 made of woven fiberglass, epoxy resins containing hollow glass beads, or other insulators.

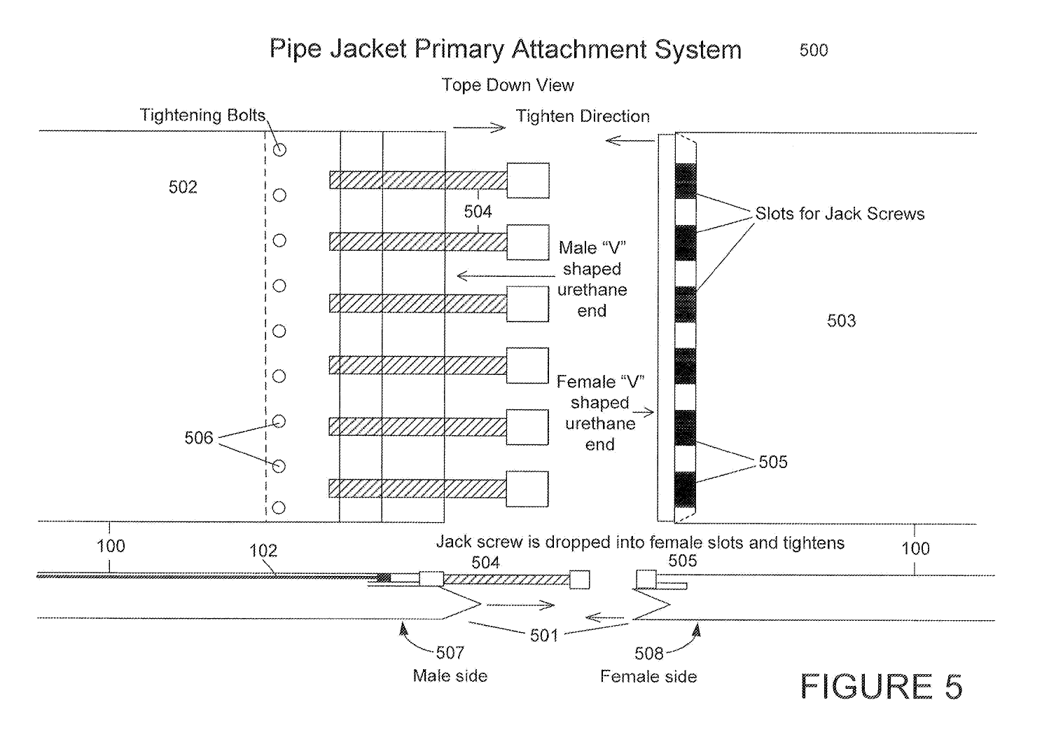

FIG. 5 shows a primary attachment system 500 for the pipe jacket 100 according to one embodiment of the invention. The pipe jacket 100 may be employed in extreme environments, and it applies a force to the pipeline exceeding the normal maximum operating pressure of the liquid or gas flowing through the pipeline, as discussed above. The primary attachment system 500 of FIG. 5 accordingly provides a secure, tight, and rugged connection between the ends 501 of the pipe jacket 100. A first side 502 of the pipe jacket 100 has fasteners, or “jack screws” 504, and a second side 503 of the pipe jacket 100 has receptacles 505 to accept the jack screws 504. The jack screws 504 may be alien type bolts, other standard bolt types, or proprietary bolts. The jack screws 504 fit into the receptacles 505. The jack screws 504 may be attached to the ballistic layer 102 with tightening screws 506. By tightening the jack screws 504, the ends 501 of the pipe jacket 100 are drawn together tightly enough to cause the pipe jacket 100 to exert a pressure on the pipeline surface greater than the normal maximum operating pressure of the pipeline. While jack screws 504 are used in FIG. 5, it should be noted that other attachment systems may be employed to fit the pipe jacket 100 on the pipeline surface such that the pressure exerted by the pipe jacket 100 on the pipeline surface is greater than the normal maximum operating pressure. Additionally, the ends 501 of the pipe jacket 100 may be shaped in such a way to fit securely against one another. FIG. 5 depicts a male v-shaped end 507 for the first side 502 and a female v-shaped end 508 for the second side 503, but other shapes are possible.

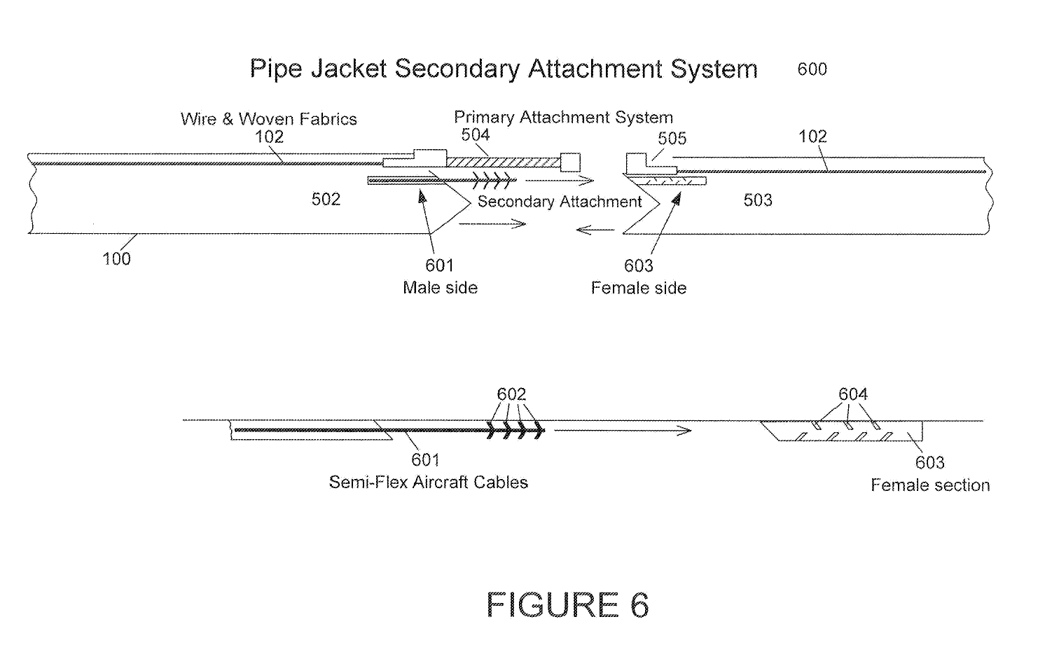

FIG. 6 shows a secondary attachment system 600 for the pipe jacket 100. This secondary attachment system 600 may ensure that the ends 501 of the pipe jacket 100 cannot be cut apart by vandalism, bomb blast, industrial accidents, or other causes. Secondary attachment cables 601, semi-flexible aircraft cables in FIG. 6, may extend from the first side 502 of the pipe jacket 100. These secondary attachment cables 601 may have cones 602 spaced at regular intervals along their length. Secondary attachment tubes 603 for accepting the secondary attachment cables 601 may be disposed along the second side 503 of the pipe jacket 100. These secondary attachment tubes 603 contain clips 604 spaced at the same intervals as the cones 602 of the secondary attachment cables 601. As seen in FIG. 6, the cones 602 and clips 604 are angled such that they may pass one another during tightening, but cannot be pulled apart afterwards. They form a one way ratchet, preventing the two ends 501 from sliding apart or releasing tension.

It will be appreciated that numerous modifications to and departures from the embodiments described above will occur to those having skill in the art. For example, the various embodiments of FIGS. 1-4 may be used together in various combinations depending on the needs of the application. A pipe jacket may include all, some, or none of the optional features such as the blast resistant layer, the anti-drill fabric layer, and the thermal insulation layer. Thus, it is intended that the present invention covers all modifications and variations of the invention that fall within the scope of the claims and their equivalents.

What is claimed is:

1. A pipe jacket assembly comprising:
a pipe jacket comprising a first end, a second end, a top layer, a ballistic fabric layer disposed beneath the top layer, a bottom layer disposed along a pipeline surface surrounding an inner pipeline, and a self-sealing layer disposed between the ballistic fabric layer and the bottom layer, the self-sealing layer further comprising a plurality of compressible polymers and a self-sealing mixture; and
an attachment system for fastening the first end to the second end, wherein a pressure exerted by the pipe jacket on the pipeline surface after fastening exceeds a normal maximum operating pressure of the inner pipeline.

2. The pipe jacket assembly of claim 1, wherein an adhesive is disposed between the bottom layer and the pipeline surface.

3. The pipe jacket assembly of claim I, further comprising a blast resistant layer disposed above the top layer.

4. The pipe jacket assembly of claim 1, further comprising a drill stopping layer disposed above the top layer.

5. The pipe jacket assembly of claim I, wherein the top layer and the bottom layer are made of an anti-corrosive material.

6. The pipe jacket assembly of claim 1, further comprising a thermal insulation layer disposed above the top layer.

7. The pipe jacket assembly of claim 6, wherein the thermal insulation layer comprises:
an epoxy resin; and
a plurality of beads disposed within the epoxy resin, wherein each of the plurality of beads contains a vacuum.

8. The pipe jacket assembly of claim 6, wherein the thermal insulation layer comprises a honey comb structure that contains a vacuum.

9. The pipe jacket assembly of claim 1, wherein the attachment system further comprises:
at least one fastener disposed on the first end; and
at least one receptacle disposed on the second end,
wherein the at least one fastener is fastenable to the at least one receptacle in a manner such that the first end becomes disposed along the second end.

10. The pipe jacket assembly of claim 1, wherein the attachment system further comprises:
at least one secondary attachment cable disposed on the first end, the at least one secondary attachment cable comprising a semi-rigid cable and at least one cone disposed at a set distance along the semi-rigid cable; and
at least one secondary attachment tube disposed on the second end, the at least one secondary attachment tube comprising an inner tube surface and at least one clip disposed at the set distance along the inner tube surface,
wherein the at least one secondary attachment cable is fastenable to the at least one secondary attachment tube in a manner such that the at least one cone and the at least one clip prevent the first end and the second end from separating.

11. A pipe assembly comprising:
a pipe adapted to operate at a normal maximum operating pressure; and
a pipe jacket assembly comprising:
a) a pipe jacket comprising a first end, a second end, a top layer, a ballistic fabric layer disposed beneath the top layer, a bottom layer disposed along a surface of the pipe, and a self-sealing layer disposed between the ballistic fabric layer and the bottom layer, the self-sealing layer further comprising a plurality of compressible polymers and a self-sealing mixture; and
b) an attachment system for fastening the first end to the second end, wherein a pressure exerted by the pipe jacket on the surface of the pipe after fastening exceeds the normal maximum operating pressure of the pipe.

12. A method for protecting a pipe comprising:
determining a normal maximum operating pressure of a pipe;
placing a pipe jacket around a surface of the pipe, wherein the pipe jacket comprises a first end, a second end, a top layer, a ballistic fabric layer disposed beneath the top layer, a bottom layer disposed along a surface of the pipe, and a self-sealing layer disposed between the ballistic fabric layer and the bottom layer, the self-sealing layer further comprising a plurality of compressible polymers and a self-sealing mixture; and
fastening the first end to the second end so that a pressure exerted by the pipe jacket on the surface of the pipe after fastening exceeds the normal maximum operating pressure of the pipe.
